(19) United States
(12) Patent Application Publication
(10) Pub. No.: US 2025/0246643 A1
(43) Pub. Date: Jul. 31, 2025

(54) SEPARATOR PLATE FOR AN ELECTROCHEMICAL SYSTEM

(71) Applicant: Reinz-Dichtungs-GmbH, Neu-Ulm (DE)

(72) Inventors: Claudia KUNZ, Ulm (DE); Thomas STÖHR, Laupheim (DE); Oliver SCHIMMELE, Pfaffenhofen (DE)

(21) Appl. No.: 19/041,716

(22) Filed: Jan. 30, 2025

(30) Foreign Application Priority Data
Jan. 31, 2024 (DE) 20 2024 100 481.7

(51) Int. Cl. H01M 8/0258; C25B 13/02

(52) U.S. Cl. CPC H01M 8/0258; C25B 13/02

(57) ABSTRACT

The present disclosure relates to a separator plate for an electrochemical system, in particular a fuel cell system. The separator plate has at least one through-opening for passing a fluid through the separator plate, at least one distribution area having a plurality of first channels and first webs formed between each two first channels, and at least one flow field, which is in fluid communication with the through-opening via the distribution area and which has a plurality of second channels and second webs formed between each two second channels. First ends of the first webs face ends of the second webs and/or merge into the ends of at least selected ones of the second webs. First distances between the respective first ends of mutually adjacent first webs are inhomogeneous.

### CROSS REFERENCE TO RELATED APPLICATION

This application claims priority to German Utility Model Application No. 20 2024 100 481.7, entitled “SEPARATOR PLATE FOR AN ELECTROCHEMICAL SYSTEM”, filed Jan. 31, 2024. The entire contents of the above-identified application is hereby incorporated by reference for all purposes.

### TECHNICAL FIELD

The present disclosure relates to a separator plate for an electrochemical system, in particular a fuel cell system.

### BACKGROUND AND SUMMARY

Known electrochemical systems usually comprise a large number of separator plates, which can be designed in particular as bipolar plates, each composed of two individual plates. The separator plates are typically arranged in a stack so that each two adjacent separator plates enclose an electrochemical cell. The separator plates can be used, for example, for the electrical contacting of the electrodes of the individual electrochemical cells (e.g. fuel cells) and/or the electrical connection of neighboring cells (series connection of the cells). The separator plates can also be used to dissipate heat generated in the cells between the separator plates. Such waste heat can be generated, for example, during the conversion of electrical or chemical energy in a fuel cell.

The separator plates usually each have at least one through-opening. In the separator plate stack of the electrochemical system, the through openings of the stacked separator plates, which are aligned or overlap at least partially, form media channels for media supply or discharge.

The separator plates can also have channel structures for supplying an active area of the separator plate with one or more of the media and/or for discharging media.

The separator plate typically comprises a so-called flow field, which forms the active area of the separator plate, as well as at least one distribution area, which connects a through-opening to the flow field in a fluid-conducting manner. Depending on the direction of flow out of the flow field or into the flow field, the distribution area can also be referred to as a collection area, that means that it can have a fluid-collecting function. In the following, the term distribution area includes both a possible fluid-collecting function and a possible function that distributes the fluid across the flow field.

By means of the distribution area, the fluid, which typically emerges from the through-opening along a comparatively small edge area, can be introduced into the flow field (or vice versa). The latter typically has a significantly larger inlet area for the fluid compared to the edge area of the through-opening. This inlet area can, for example, extend along more than half of a width dimension of the separator plate. The fluid-conducting structures and, in particular, channels of the distribution area must be suitably aligned so that the fluid connection of the aforementioned differently sized areas of the through-opening and flow field is successful, whereby these areas or sections are generally not centered in relation to each other. Up to now, this has typically resulted in different duct lengths within the distribution area.

As explained in more detail below, the different channel lengths are particularly pronounced in distribution areas that have an at least approximately triangular base area. For deviating and in particular essentially rectangular distribution areas, as known for example from WO 2023 245 713 A1, the channel lengths cannot vary to a comparable extent.

It is generally desirable to further improve the efficiency of the operation of electrochemical systems. The present application is directed accordingly to this task, in particular in connection with distribution areas having significantly different channel lengths, such as the aforementioned at least approximately triangular distribution areas.

According to the present disclosure, it was recognized that there is potential for improving the efficiency of previous separator plates, in particular in connection with the passage of the fluid through the at least one distribution area. To be more precise, it was recognized that the typically different channel lengths of the distribution area are associated with different and more precisely channel-specific mass flows when flowing through the distribution area. As a consequence, flows are also generated in the flow field through the channels present there with a correspondingly different mass flow, depending on which channel of the distribution area the channels of the flow field are connected to in a fluid-conducting manner.

These significantly different mass flows in the prior art arise in particular because the number of channels of the flow field, which are connected to a respective channel of the distribution area in a fluid-conducting manner and, in particular, face it, is essentially constant. In other words, in previous solutions, a predominant number of the channels of the distribution area each supply an equal number of channels in the flow field with fluid from the through-opening (or vice versa), irrespective of their respective lengths. The present disclosure, on the other hand, is based in particular on the insight that this ratio of channels connected to each other in a fluid-conducting manner can be used as a degree of freedom in order to reduce the difference between the mass flows of the channels when flowing through the distribution area and/or the flow field. In particular, it can be provided that channels of the distribution area with a comparatively short length and thus a higher mass flow are connected in a fluid-conducting manner to a higher number of channels of the flow field than channels of the distribution area with a comparatively long length and thus correspondingly low mass flows. This can be achieved structurally by the inhomogeneous distances between webs of the distribution area, as disclosed here.

In particular, the present disclosure proposes a separator plate for an electrochemical system, comprising:
at least one through-opening for passing a fluid through the separator plate, at least one distribution area comprising a plurality of first channels and first webs formed between each two first channels,
at least one flow field, which is in fluid connection with the through-opening via the distribution area and which has a plurality of second channels and second webs formed between each two second channels,
wherein first ends of the first webs face ends of the second webs and/or merge into ends of at least selected ones of the second webs, wherein first distances between the respective first ends of mutually adjacent first webs are inhomogeneous.

As is generally customary, it may be provided that distances between the ends of the second webs facing the distribution area and/or merging at least partially into webs there are homogeneous. At least these distances can vary less in comparison to the first distances of the first ends of the distribution area webs. As explained below, the distances under consideration can be viewed in the width direction of the separator plate and/or orthogonal to a flow direction (see main flow direction below) through the flow field.

As a result of the inhomogeneous first distances, the channel width can be varied in the area of the first ends. Additionally or alternatively, the number of those channels of the flow field that are at least predominantly or exclusively supplied with fluid by a respective channel of the distribution area or into which they predominantly or exclusively introduce fluid can be varied. This can be used to vary this number according to the expected mass flows of the distribution area channels. The greater the mass flow, the more channels of the flow field may be connected to a channel of the distribution area in a fluid-conducting manner and/or face it.

According to the above, for example only the first distances that are between first webs that adjoin a channel on both sides or that are arranged between two channels can be considered.

According to a further embodiment, the first ends of the first webs may be distributed along a width axis of the separator plate, and the distribution area may comprise a first outermost first web and a second outermost first web as viewed along the width axis, wherein inner first webs are arranged between these two outermost first webs, wherein inner first webs are arranged between these two outermost first webs, and wherein for the inner first webs first distances between the respective first ends of mutually adjacent first webs are inhomogeneous. The respective distances between the outermost webs and an outermost contour delimiting the distribution area can be deliberately not considered here. This takes into account the fact that in the prior art the distance of the inner first webs is usually homogeneous, although it was recognized according to the present disclosure that there is a high potential for efficiency improvements, particularly in connection with these inner first webs.

The separator plate can be characterized by a longer dimension along a longitudinal axis and a shorter dimension along a width axis that is orthogonal to the longitudinal axis. For example, the separator plate can have a rectangular shape or, in other words, a rectangular footprint, in each case with a correspondingly shorter and a longer dimension. The width axis or width dimension can extend orthogonally to a main flow direction through the flow field. This main flow direction can generally be determined by the orientation of the channels and/or webs of the flow field. For example, the main flow direction can run parallel to the longitudinal axes of the channels and/or webs or can coincide with such a longitudinal axis. In the case of corrugated flow fields, the main flow direction corresponds to the macroscopic flow direction, neglecting amplitudes on both sides. Additionally or alternatively, the width axis or an axis parallel thereto can be aligned such that it is opposite the first ends of the first webs and/or the ends of the second webs, extends along them and/or intersects them.

Opposing webs and/or channels can generally be understood to mean that these structures merge or align with one another at the latest when the webs and/or channels are virtually extended and/or viewed along a respective longitudinal axis. Additionally or alternatively, a fluid guided in one channel can be guided into an opposite channel along, for example, a straight or curved flow path and/or along a flow path that corresponds to an extension of the respective longitudinal axes of the channel.

According to a further embodiment, the separator plate also has a transition region in which the first ends of the first webs face the ends of the second webs and/or in which the first ends of the first webs merge into the ends of the at least selected second webs, the transition region being lowered, with respect to a height axis running perpendicular to a plane of the separator plate, relative to the flow field and/or the distribution area. In particular, the maximum height of the transition area, especially of the webs in the transition area, can be considered in comparison to the average maximum heights of the webs of the distribution area and flow field, whereby this maximum height can be lowered compared to these average maximum heights. A transition area lowered in this way provides a free space for accommodating other components, such as the overlap area of a reinforcing edge of a membrane electrode assembly (MEA).

In a manner known per se, the surface plane can be defined, for example, by an edge of a separator plate and/or by those flat areas which are not deformed as a result of an embossing or deep-drawing process, for example, to form the web-channel structures or beads described herein.

According to a further embodiment, the fluid in the flow field flows along a main flow direction, to which all of the above explanations can apply, and:
the first webs and/or first channels each run at an angle to this main flow direction, e.g. at an angle other than 0°, and/or
a virtual connecting line of the first ends of the first channels is substantially orthogonal to the main flow direction or at least at an angle of more than 75° and less than 105°, and/or
the distribution area extends along an entire width of the flow field, the width being measured orthogonally to the main flow direction and/or along a width axis of the separator plate as explained above, and/or
the first distances are measured orthogonally to the main flow direction. Alternatively, the first distances can be measured orthogonally to the longitudinal axis of a second channel enclosed by two adjacent webs.

In principle, the inhomogeneous web distance and the resulting inhomogeneous channel widths can occur along the entire width of the flow field.

If there is a wave-shaped connecting line between the first ends of the first channels, the virtual connecting line can, for example, be the connecting line of the maximum wave crests that point away from the flow field.

According to a further embodiment, the distances between the respective ends of mutually adjacent second channels are homogeneous or are at least less inhomogeneous than the first distances. Alternatively or additionally, the number of first channels is less than the number of second channels, whereby in particular the number of first channels is not more than half as large or not more than one third as large as the number of second channels. It has been shown that these measures are particularly reliable in achieving the desired improvement in efficiency.

According to a further embodiment, the first ends of the first webs are distributed along a width axis of the separator plate and the distribution area has a first outermost first web and a second outermost first web as viewed along the width axis. These can enclose between them, and/or surround, further inner first webs.

The first outermost first web and in particular its first end can be positioned closer to the through-opening than the second outermost first web and in particular its first end. The distances can be measured along or parallel to a surface plane and/or a surface of the separator plate. For example, the shortest straight lines that connect the corresponding first webs and in particular their first ends with the through-opening and in particular with a fluid outlet area and/or a geometric center thereof can be considered.

Along the width axis and viewed from the first outermost first web in the direction of the second outermost first web, the first distances can decrease and/or not increase, at least in sections. Additionally or alternatively, along the width axis in the opposite direction, e.g. viewed from the second outermost first web in the direction of the first outermost first web, the first distances can increase at least in sections. For example, within the first half of a section from the first outermost first web to the second outermost first web, the first distances can be higher, at least on average, than within the second half of this section. By providing appropriately distributed distance inhomogeneities, mass flow differences that would otherwise occur can be at least partially compensated for and the operating efficiency of the electrochemical system can be improved.

Additionally or alternatively, the channel lengths in the distribution area can increase and/or not decrease, at least in sections, along the direction from the first outermost first web to the second outermost first web and/or can be at least on average higher within a first half than within the second half. In particular, the second outermost first web can be the longest first web. The distance inhomogeneities described above can represent efficiency-increasing compensations for this channel length distribution.

A further embodiment provides that a maximum first distance is present at least between the first outermost first web and a further first web directly adjacent thereto, which may be a correspondingly inner web, and/or that a minimum first distance is present at least between the second outermost first web and a further first web directly adjacent thereto, which may be a correspondingly inner web.

In the context of the present disclosure, outermost structures delimiting the distribution area, which are not enclosed by channels on both sides and/or are adjacent to channels on both sides, cannot be regarded as first webs of the distribution area. This applies, for example, to plateau surfaces and/or sealing beads that delimit the distribution area and typically only adjoin a single outermost channel of the distribution area.

According to a further embodiment, each first channel is arranged to supply fluid to or receive fluid from at least one associated second channel, wherein the number of second channels associated with a respective first channel is inhomogeneous. In particular, the number of second channels assigned to a respective one of the first inner channels arranged between two inner first webs can be inhomogeneous.

According to a further embodiment, a respective width of the first webs is constant or does not vary by more than 20% along a respective length of a first web; and/or the respective widths of the first webs are identical and/or do not deviate from each other by more than 20%. However, the mean and/or maximum and/or minimum widths of the first channels, for example, may be different from one another, for example as a result of the inhomogeneous distance of the first webs disclosed herein. Additionally or alternatively, the widths of at least selected first channels can vary along their respective lengths, for example by at least 10% and/or at least 20%.

The above measures have proven to be advantageous for achieving efficient fluid flow in the distribution area. For example, comparatively narrow webs can be formed and the available installation space can be used to accordingly widen the cross-section of the channels.

According to a further embodiment, the first webs and/or the first channels are essentially kink-free and/or essentially curvature-free over at least two thirds of their length. This can be understood to mean, for example, that any angles in the course of the first webs and/or first channels are no more than 20°. In particular, the first webs and/or first channels can run in a straight line over at least two thirds of their length. For example in the case of first webs that merge into second webs, the first webs can have a curvature in an area that is closer to the second webs than to the associated through-opening. All the first webs of a distribution area may have a curvature that points in the same direction; and the radius may point away from both the flow field and the side edge of the separator plate that is closest to the through-opening fluidically connected to this distribution area. Additionally or alternatively, the first webs can run non-parallel to each other along at least half of their length. In this way, too, the distance inhomogeneity of the first ends disclosed here can be implemented in a structurally compact manner and the available installation space can be used to form correspondingly wide flow cross-sections of the channels.

According to a further embodiment, the first webs are no more than five times, optionally no more than four times and optionally no more than three times as wide as the second webs. Additionally or alternatively, the first channels can be no more than eight times as wide as the second channels, optionally no more than six times and optionally no more than five times as wide, at least in the middle third of their longitudinal extension.

To determine the widths of the webs and channels, first determine the total height that the webs and channels together span perpendicular to the plane of the separator plate. In the context of this disclosure, a web width can then be generally defined as the maximum width of the area extending above half total height. A channel width, on the other hand, can be defined as the width of the area that extends below half the total height. This can enable a meaningful determination of the widths, for example, independent of any production radii.

According to one variant, the width of at least some of the first channels decreases in the direction towards the flow field. Alternatively or additionally, the width of at least some of the first channels can increase in the direction towards the flow field. In particular, a combination can also be provided whereby the width of some of the first channels increases in the direction towards the flow field and the width of some of the other first channels decreases in the direction towards the flow field. It is also possible that at least selected first channels with a constant width are provided, particularly in the context of such a combination. The above variants open up additional degrees of freedom to ensure efficient flow through the distribution area.

According to a further embodiment, within the distribution area and/or within a region of the separator plate that comprises the distribution area and at least one scaling bead adjacent thereto, a distance between regions of maximum height is not more than 5 mm and optionally not more than 3 mm. These areas of maximum height can form a contact surface for neighboring components of the electrochemical system. By limiting the distances between these areas, the size of regions of the separator plate without corresponding contact surfaces can be reduced. In particular, the adjacent sealing bead can be a scaling bead that surrounds and/or seals the through-opening at least in sections. In a manner known per se, such a sealing bead can be locally perforated in order to provide a fluid connection between the through opening and the distribution area.

Optionally, the above distance limits apply for example in connection with first outermost first channels, or webs adjacent to the first outermost first channels, e.g. in regions with comparatively short first channels. There are typically wide channels, but these should not exceed the aforementioned distance limits so that sufficient structural support can still be guaranteed.

According to a further embodiment, second ends of the first webs can face the through-opening and be connected to each other by a virtual connecting line. This connecting line can be straight, but can also have a non-straight shape, for example a multiple- or single-kinked shape and/or a curved shape. The through-opening can be arranged along a first edge section for a fluid-conducting connection with the distribution area, for example by providing corresponding fluid channels and/or openings in an optional circumferential sealing bead. The extension along the first edge section does not require a constant distance of the second ends of the first webs to this first edge section, although this can be provided as an option. In general, the extension along the first edge section can comprise that this extension deviates locally by no more than 90° and optionally no more than 45° from a direction of the first edge section.

The first edge section can extend along at least one third and optionally along at least half of the virtual connecting line. Figuratively speaking, this means that fluid exchange with the through-opening and thus with the associated media channel is made possible over a correspondingly large area of the through-opening. This also makes it possible to distribute the second ends of the first webs along a correspondingly large area, which provides additional degrees of freedom for forming the extensions of and distances between the first webs disclosed here.

Additionally or alternatively, second ends of the first webs face the through-opening and are connected to one another by a virtual connecting line, wherein the virtual connecting line and an edge section of the through-opening, which may comprise an edge delimiting the through-opening, extend at least over half, optionally over at least 70%, of their course at a constant distance from one another. Only a portion of the edge section opposite the second ends need be considered, e.g. the constant distance can be present along at least half or at least 70% of the course of this portion. Alternatively, only such a portion of the edge of the through-opening need be regarded as an edge section, which is opposed by the second ends of the first webs.

If the separator plate is divided into two halves along a dividing line that runs parallel to the main flow direction of the flow field, the second ends of the first webs of a distribution area may all be arranged in the same half of the separator plate as the nearest through-opening with which they are in direct fluidic communication. If the through-opening has a strongly asymmetrical shape, e.g. with projections, the half in which the majority of the area of the through-opening lies is relevant.

According to a further development, the first channels and/or the first webs are at least five times and optionally at least ten times as long as they are wide. This applies optionally to at least 80% of the first channels and/or at least 80% of the first webs.

In general, it may be provided within the scope of the present disclosure that the webs are locally interrupted along their extension from the through-opening in the direction of the flow field (or vice versa), for example by local depressions. Such interruptions can, for example, enable targeted cross-flows between neighboring channels. Such lowerings can divide the webs into different sections. In such a case, the total length of the webs can also refer to the entire length of the webs between their respective first and second ends and in particular include all possible partial sections of a web.

Furthermore, at least some of the distances between the respective second ends of adjacent first webs, e.g. the ends opposite the through-opening, may be homogeneous. The second ends can therefore have the same distance and thus a comparable flow cross-section, although the distance of the first ends is inhomogeneous.

If the second ends of the first webs are distributed along a width axis of the separator plate and the distribution area has a first outermost first web and a second outermost first web as viewed along the width axis, and if first inner webs are arranged between these two outermost first webs, distances between the respective second ends of mutually adjacent first webs may be homogeneous for the inner first webs. The homogeneity of the second ends should therefore apply to the first inner webs; any deviation of the outermost webs can be disregarded in this consideration.

The present disclosure also relates to a separator plate for an electrochemical system, with:
at least one through-opening for passing a fluid through the separator plate,
at least one distribution area comprising a plurality of first channels and first webs formed between each two first channels,
at least one flow field which is in fluid connection with the through-opening via the distribution area,
wherein second ends of the first webs face the through-opening, wherein distances between the respective second ends of mutually adjacent second webs are inhomogeneous. These distances correspond to the second distances shown here.

For example, in this context, the second ends of the first webs may be distributed along a width axis of the separator plate and the distribution area may have a first outermost first web and a second outermost first web when viewed along the width axis,
wherein inner webs are arranged between these two outermost first webs, and wherein distances between the respective second ends of mutually adjacent first webs are inhomogeneous for the inner first webs.

Optionally, in any embodiment disclosed here, the distribution area has a substantially and/or at least approximately triangular basic shape, with the triangle in particular forming an obtuse angle on the side opposite the flow field. The legs of this obtuse angle can merge directly into a side of the triangle, which side may extend orthogonal to the main flow direction, or there can be short transition sections at one or both of these leg ends, resulting in an asymmetrical quadrilateral or pentagonal shape overall. If the triangle obtained by approximation is considered, it has the smallest angle at the corner facing the flow field, which is furthest away from the through-opening fluidically connected to the flow field and the distribution area and adjacent to the latter; this angle can be between 7° and 40°.

An approximate triangular shape can exist, for example, if there are three sides that together define at least 80% or even at least 90% of the circumferential length of the distribution area. The sides can be inclined towards each other in the manner of a triangle and/or connected to each other at their ends. In particular, one of the sides can connect the other two sides and be inclined towards them.

The shape of the distribution area and in particular the substantially and/or at least approximately triangular shape of the distribution area may additionally or alternatively comprise the following: The distribution area and in particular its base surface or footprint, as shown for example in a top view of the separator plate, has a first side and a second side. The first side can be closer to the through-opening than the second side. The second side can be closer to the flow field than the first side. The first and second sides can be inclined towards each other and/or be spaced apart from each other by the channels of the distribution area and/or enclose these channels between them, at least in sections. The first side can form or comprise an area via which fluid can enter the distribution area from the through-opening and/or vice versa. The second side can form or include an area via which fluid can enter the distribution area from the flow field and/or vice versa. The first side can include the second ends of the first webs. The second side can include the first ends of the first webs.

The first and second sides can be of different lengths. The length deviation can be at least 10%, optionally at least 25% and optionally at least 50% or at least 75%. Additionally or alternatively, the length deviation can be no more than 150% or no more than 200% or no more than 300%. Efficient flow conditions can be achieved by means of the length ratios described and a deviation from the rectangular distribution areas of the state of the art can be achieved. The first side can be shorter than the second side, especially when using one of the length ratios mentioned.

The distribution area can also be at least partially limited by at least a third side. In particular, the first and second sides can be connected to each other by this third side. The third side may extend along a longest channel and/or outermost web of the distribution area, for example along the second outermost web disclosed herein. For example, it can be directly adjacent to such a web. The third side may comprise a length that differs from the first and/or second side, and is longer than the first side. For example, the third side can be at least 10%, optionally at least 25% and optionally at least 50% or at least 75% longer than the first side. Additionally or alternatively, the length deviation can be no more than 150% or no more than 200% or no more than 300%.

By providing these three sides, which can each be inclined to one another, the distribution area can be at least approximately triangular in shape. Any of the first, second and third sides can be at least partially straight. If a fourth side is also provided, which for example lies opposite the third side and accordingly adjoins a first outermost web disclosed herein and/or extends parallel thereto, this fourth side can be significantly smaller than the third side. For example, the length of this fourth side cannot be more than 10% of the length of the third side. In this case in particular, the basic shape or footprint of the distribution area can still be described as at least essentially triangular.

If the basic shape or footprint of the distribution area is considered to be quadrangular or to have even more corners, at least selected opposite sides can have different lengths and, for example, a difference in length of at least 20% or even at least 50%. This applies in particular to a first side near the through-opening and a second side near the flow field. These can be defined analogously to the first and second sides of an at least approximate triangular shape described above, in particular with regard to their length ratios.

In summary, the shape of the distribution area can be described as at least approximately triangular or, in the case of four or more corners, the first and second sides described can be of different lengths.

In accordance with the present disclosure, it was consequently also recognized that the fluid exchange with the through-opening offers potential for improvement with regard to the flow behavior of the distribution area, for which in turn the distances between adjacent webs and/or associated channel widths can be suitably adapted. For example, channels along the course of which reduced mass flows occur without further measures, can have larger channel widths in the area of their second ends than channels in which comparatively larger mass flows occur. The width of the channel ends can be based for example on the results of simulation calculations.

Any embodiments described herein regarding distance of the first ends of the first webs may be combined with any embodiments described herein regarding distance of the second ends of the first webs.

Embodiments of the present disclosure are explained below with reference to the accompanying schematic figures. The same reference symbols can be used for the same features across all figures. Within a respective figure, not all instances of a feature can be provided with the reference sign assigned to this feature.

### BRIEF DESCRIPTION OF THE FIGURES

FIG. 1 shows a perspective view of an electrochemical system, which can in principle comprise separator plates according to one embodiment of the present disclosure.

FIG. 2 shows individual perspective views of separator plates according to the state of the art, which can also be used in principle in the electrochemical system shown in FIG. 1.

FIGS. 3A and 3B are schematically simplified partial views of a separator plate according to examples of the prior art.

FIG. 4 is a schematically simplified partial view of a separator plate according to one embodiment of the present disclosure.

FIG. 5 is a schematically simplified partial view of a separator plate according to a further embodiment of the present disclosure.

FIG. 6 is a schematically simplified partial view of a separator plate according to a further embodiment of the present disclosure.

FIG. 7 is a schematically simplified partial view of a separator plate according to a further embodiment of the present disclosure.

FIG. 8 is a schematically simplified partial view of a separator plate according to a further embodiment of the present disclosure.

FIG. 9 is a schematically simplified partial view of a separator plate according to a further embodiment of the present disclosure.

FIG. 10 is a diagram illustrating the effects of the present disclosure with regard to improved mass flow homogeneity in the distribution area.

### DETAILED DESCRIPTION

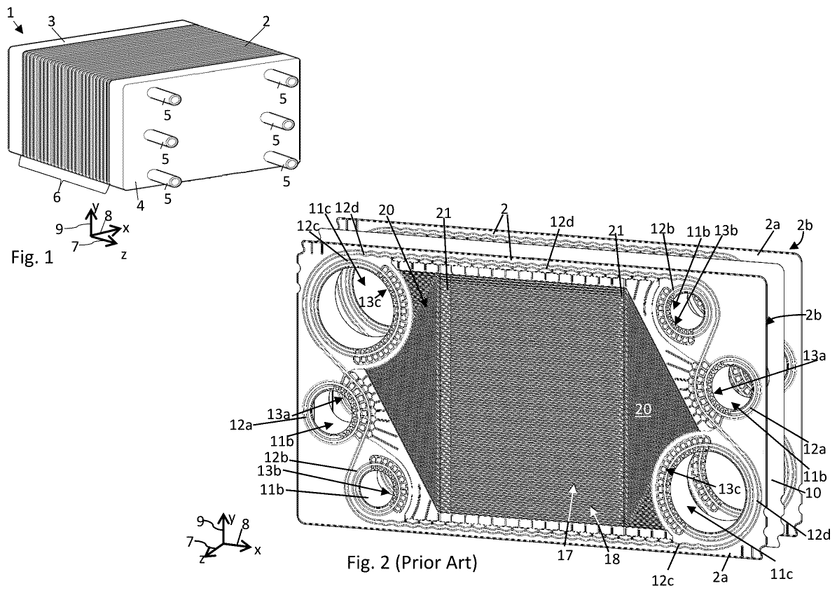

FIG. 1 shows an electrochemical system 1 with a plurality of identical metallic separator plates 2, which are arranged in a stack 6 and stacked along a z-direction 7. The separator plates 2 of the stack 6 are usually clamped between two end plates 3, 4. The z-direction 7 is also called the stacking direction. In this example, system 1 is a fuel cell stack. Each two adjacent separator plates 2 of the stack 6 therefore delimit an electrochemical cell, which is used, for example, to convert chemical energy into electrical energy. To form the electrochemical cells of system 1, a membrane electrode assembly (MEA) 10 is arranged between adjacent separator plates 2 of stack 6 (see e.g. FIG. 2). The MEA 10 typically contains at least one membrane, e.g. an electrolyte membrane. Furthermore, a gas diffusion layer (GDL) can be arranged on one or both surfaces of the MEA 10. The MEA 10 also often includes a frame-shaped reinforcing layer that frames the electrolyte membrane and reinforces it. The reinforcing layer is usually electrically insulating and prevents a short circuit from occurring during operation of the electrochemical system 1.

In alternative embodiments, the system 1 can also be designed as an electrolyzer, electrochemical compressor or redox flow battery. Separator plates 2 can also be used in these electrochemical systems. The structure of these separator plates can then correspond to the structure of the separator plates 2 described in more detail here, even if the media fed onto or through the separator plates in an electrolyzer, in an electrochemical compressor or in a redox flow battery may differ in each case from the media used for a fuel cell system.

Together with an x-axis 8 and a y-axis 9, the z-axis 7 spans a right-handed Cartesian coordinate system. The separator plates 2 each define a plate plane, whereby the plate planes can be surface planes of individual plates 2a, 2b (see FIG. 2), from which a respective separator plate 2 is composed, or whereby the plate planes can run at least parallel to such surface planes. The plate planes or surface planes are aligned parallel to the x-y plane and therefore perpendicular to the stacking direction or z-axis 7. The end plate 4 generally has a large number of media connections 5 via which media can be supplied to the system 1 and via which media can be discharged from the system 1, whereby the media connections 5 are sometimes referred to as ports. These media that can be supplied to and discharged from system I can include, for example, fuels such as molecular hydrogen or methanol, reaction gases such as air or oxygen, reaction products such as water vapor or depleted fuels or coolants such as water and/or glycol.

In an electrochemical system 1, as shown in FIG. 1, both known separator plates 2 according to the state of the art and separator plates 2 according to the present disclosure can be used.

FIG. 2 shows a perspective view of two adjacent separator plates 2 according to examples of the prior art, which can be used in an electrochemical system of the type of system 1 in FIG. 1. With the exception of the design of the distribution area disclosed herein and its fluid exchange with a flow field, the following remarks on this separator plate 2 can also apply to separator plates 2 according to the present disclosure of the present disclosure.

FIG. 2 also shows a membrane electrode assembly (MEA) 10 arranged between the adjacent separator plates 2 and known from the prior art, whereby the MEA 10 in FIG. 2 is largely concealed by the separator plate 2 facing the observer. The separator plate 2 is formed from two individual plates 2a, 2b that are joined together with a material bond, of which only the first individual plate 2a facing the viewer is visible in FIG. 2, which conceals the second individual plate 2b. The individual plates 2a, 2b can each be made from a metal sheet, e.g. a stainless-steel sheet. The individual plates 2a, 2b can, for example, be welded together along their outer edge, e.g. by laser welding.

The individual plates 2a, 2b typically have through-openings that are aligned with each other and form the through-openings 11a-c of the separator plate 2. When a plurality of separator plates 2 are stacked, the through-openings 11a-c form conduits or media channels that extend through the stack 6 in the stacking direction 7 (see FIG. 1). Typically, each of the conduits formed by the through openings 11a-c is in fluid communication with one of the ports 5 in the end plate 4 of the system 1.

For example, coolant can be introduced into the stack 6 via conduits formed by one of the through-openings 11a of the separator plates 2, while the coolant is discharged from the stack 6 via an opposite through-opening 11a. The conduits formed by the through openings 11b, 11c, on the other hand, can be designed to supply the electrochemical cells of the fuel cell stack 6 of the system 1 with fuel and with reaction gas and to discharge the reaction products from the stack 6. The media-conducting through-openings 11a-c are essentially parallel to a respective plate plane.

To seal the through-openings 11a-c from the interior of the stack 6 and from the surroundings, the first individual plates 2a each have sealing beads 12a-c, which are arranged around the through-openings 11a-c and which completely enclose the through-openings 11a-c in each case. The second individual plates 2b have corresponding sealing beads for scaling the through-openings 11a-c on the rear side of the separator plates 2 facing away from the viewer of FIG. 2 (not shown).

In an electrochemically active area 18, the first individual plates 2a have a flow field 17 with structures 14 for guiding a reaction medium along the outer side (or also front side) of the individual plate 2a on their front side facing the viewer of FIG. 2. These structures 14 are shown in FIG. 2 by a large number of webs and channels running between the webs and delimited by the webs. On the front side of the separator plate 2 facing the viewer of FIG. 2, the first individual plates 2a also each have a distribution and/or collection area 20, which is referred to here in simplified form only as distribution area 20. A transition area 21 with lowered webs can extend between the distribution areas 20 and the flow field 17 of the electrochemically active area.

The distribution area 20 comprises structures that are arranged to distribute a medium introduced into the adjacent distribution area 20 from a first of the two through-openings 11c over the flow field 17 and to collect or bundle a medium flowing from the flow field 17 towards the second of the through-openings 11c via the collection area 20. The distribution structures of the distribution and/or collection area 20 are also provided in FIG. 2 by webs and channels running between the webs and delimited by the webs.

The sealing beads 12a-12c are crossed by passages 13a-13c, each of which is molded into all individual plates 2a, 2b and which enable fluid exchange with an associated through-opening 11a-11c.

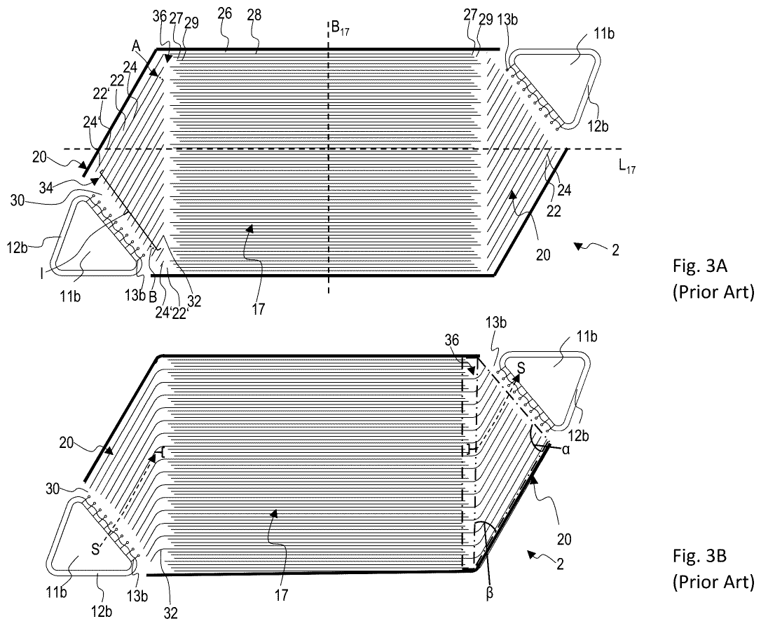

FIGS. 3A/B to 9 below each show partial views of separator plates 2 which, with the exception of the differences already mentioned, can be designed largely analogously to the example in FIG. 2. The views correspond to a top view of one of the outer sides of a respective separator plate 2. In the partial views, neither a complete surface nor the outline of a respective separator plate 2 is shown. Not all of the through-openings 11a-c analogous to FIG. 2 are shown either, but these can still be present in a respective separator plate 2.

FIGS. 3A-B first show further examples of separator plates 2 according to the prior art. These separator plates 2 have an essentially rectangular outline, which is not shown separately. They are characterized by a longitudinal axis L₁₇, which runs along the larger dimension of the rectangular shape not shown separately, and by a width axis B₁₇, which runs along the smaller dimension of the rectangular shape not shown separately. In the partial views shown in each case, two through openings 11b are shown, which are connected in a fluid-conducting manner via two distribution areas 20 and a flow field 17 arranged between the distribution areas 20. The number of through-openings 11b shown is not restrictive and, as mentioned, further through-openings 11a, 11c can also be provided, for example as shown in FIG. 2.

The distribution areas 20 comprise several elongated first channels 22 and elongated first webs 24 extending between two first channels 22 as fluid-conducting structures. As shown in FIG. 3B and also in FIG. 5 by means of dotted lines in the right half of the figure, the distribution area is essentially triangular—bounded on the left by the double-dotted line—or has an asymmetrical pentagonal shape. The triangular leg opposite the through-opening 11b also corresponds to an approximate view here. The triangle has an obtuse angle α in the range of 100-120° at the corner facing away from the flow field, which in this case is approx. 105°, the smallest angle β is in the range of 25-35°, in this case it is approximately 30° and is formed at the corner furthest away from the through-opening 11b. In all examples—of the prior art shown as well as those according to the present disclosure—the distribution areas do not have a rectangular or even approximately rectangular shape.

Additionally or alternatively, the shape of a distribution area 20 can be described as follows. Each distribution area 20 comprises sides 100, 112, 104, 106 and 108, as marked in FIG. 5 for one of the distribution areas 20, which define and/or limit its extension and/or shape and/or circumference at least in part. These sides 100, 112, 104, 106 and 108 may be arranged and/or connected to each other according to an at least approximate triangular shape. At least the first to third sides 100, 102—which approximates side 112—and 104 explained below can also be referred to as the first to third triangular legs.

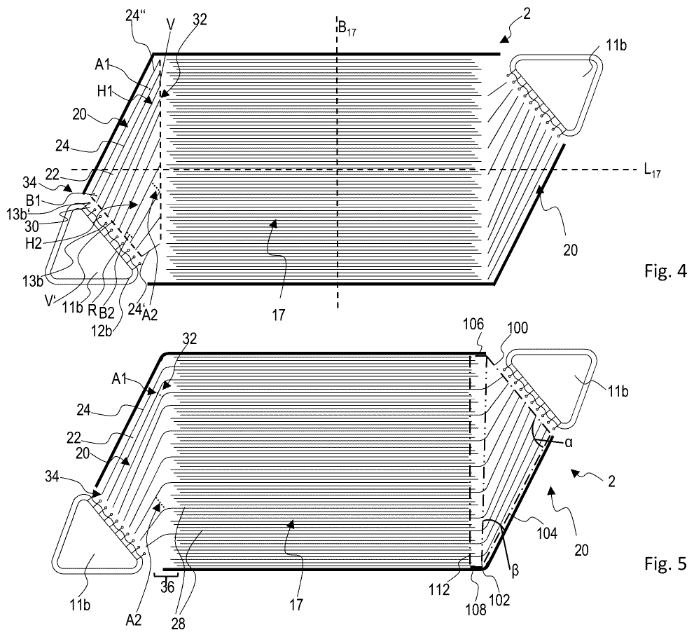

A first side 100, which may also be referred to as a first triangular leg, is located adjacent and opposite the through opening 11b and comprises the second ends 34 of the first webs 24 and first channels 22, as explained below, as well as a virtual connecting line V′, see FIG. 4.

A second side 102 comprises the first ends 32 of the first webs 24 and first channels 22, as explained below, and a virtual connecting line V, see FIG. 4.

The second side 102 is significantly longer than the first side 100 and, by way of example, approximately twice as long. The first and second sides 100, 102 are connected by a third side 104, which extends along a longest channel 22 and a second outermost first web 24″ as explained below, see FIG. 4. Considering the line 112 as the boundary between the distribution area 20 and the flow field 17, two further optional sides 106, 108 are shown, of which the first 106 is opposite the third side 104 and the second 108 is opposite the first side 102, but which are each significantly shorter than the third and first sides 104, 102 respectively. Therefore, these sides 106, 108 can also be approximately disregarded when describing the shape of the distribution area 20, e.g. it is possible to speak of an essentially triangular shape instead of a pentagonal shape. This applies in particular if these sides 106, 108, as is the case in the example shown, do not take up more than 10% and optionally not more than 5% of the total circumference of the distribution area 20. However, even if a quadrangular or pentagonal shape comprising the further side 106 or 108 is assumed, the first and second sides 100, 102, as opposite sides, are clearly different in length. This also applies if the second side extends along a line comparable to line 112 and deviates from the rectangular distribution areas of the prior art.

The flow field 17 also comprises, as fluid-conducting structures, several elongated channels, which are referred to as second channels 26, as well as several elongated webs, which are referred to as second webs 28. These correspond to the structures 14 in FIG. 2. A main flow direction through the flow field 17, which is not shown separately, runs parallel to the longitudinal axis L₁₇.

In all of FIGS. 3A/B to 9, only selected ones of the channels 22, 26 and webs 24, 28 are provided with a corresponding reference sign. Furthermore, in the description of all of FIGS. 3A/B to 9, reference can be made primarily to only one of the distribution areas 20 and for example to its interaction with the flow field 17 and/or the neighboring through-opening 11b, although the same can apply to the other distribution area 20.

In the examples in FIGS. 3A-B, the through openings 11b are again surrounded by a scaling bead 12b. This is provided with schematically indicated passages 13b in an edge section 30, which faces a respective adjacent distribution area 20.

In the examples in FIGS. 3A-B, the first webs 24 and first channels 22 of the distribution areas 20 run parallel to each other, completely or at least over a large part of their lengths but have different lengths. This results in particular from the non-central arrangement of the through openings 11b relative to the flow field 17, for example viewed along the width axis B. In order to also be connected in a fluid-conducting manner to a remote area of the flow field 17 viewed along the width axis B₁₇ from the perspective of the through openings 11b, the first channels 22 and first webs 24 leading to this remote area must be configured with a correspondingly increased length. In FIG. 3A, this concerns, for example, the upper first channels 22 and webs 24 of the left-hand distribution area 20 and the lower first channels 22 and webs 24 of the right-hand distribution area 20.

The first webs 24 and first channels 22 of the distribution areas 20 each have first ends, of which those of the first webs 24 are designated by the reference sign 32. These first ends face ends 29 of the second webs 28 and ends 27 of the second channels 26 of the flow field 17. Furthermore, the first webs 24 and first channels 22 each have second ends 34 which face the through opening 11b and, at least in most cases, face the described passages 13b.

From the first channels 22 immediately adjacent to the first ends 32 of the first webs 24, fluid passes from one of the distribution areas 20 into the flow field 17 or from the flow field 17 into one of the distribution areas 20. Doing so, a lowered transition area 36 is flowed through.

In the example shown in FIG. 3A, the first webs 24 of the distribution areas 20 do not merge into the second webs 28 of the flow field 17 but remain at a distance from them. In the example shown in FIG. 3B, the first webs 24 of the distribution areas 20 each merge into a respective second web 28 of the flow field 17; starting from a first web height in the distribution area 20, the webs in the transition region 36 decrease in height order to increase again towards the flow field 17, but only to a lesser extent. The number of second webs 28 and second channels 26 of the flow field 17 is higher than the corresponding number within the distribution areas 20.

Both in the case of FIG. 3A and in the case of FIG. 3B, the distances A between the first ends 32 of the first webs 24 of the distribution areas 20 and a respective immediately adjacent first end 32 of a further first web 24 are homogeneous. An exemplary distance A is shown in FIG. 3A. These distances A can be measured along the width axis B 17 and thus orthogonally to the longitudinal axis L₁₇ and/or a main flow direction through the flow field 17. Alternatively, these distances A can be measured orthogonally to the longitudinal axis of that first channel 22 that is bounded by the correspondingly spaced first webs 24.

The second webs 28 of the flow field 17 are also at a constant distance from each other along the longitudinal axis L₁₇. The constant distances A between the first and second webs 24, 28 result in correspondingly constant widths of the first and second channels 22, 26 formed between these webs 24, 28.

In addition, the distances B between the second ends 34 of the first webs 24 of the distribution areas 20 are also homogeneous.

Furthermore, at least the same number of, for example four, second channels 26 of the flow field 17 is located opposite at least the plurality of respective first channels 22 of one of the distribution areas 20. This becomes clear in particular from a view along a schematically entered flow path S, which illustrates a distribution of the fluid from a respective first channel 22 to a plurality of first channels 26 of the flow field 17 (and vice versa).

The foregoing refers in particular to the inner first channels 22 and the inner first webs 24 bounding them, which are arranged between outermost first channels 22′ and outermost first webs 24′, 24″. This intermediate arrangement is present in particular along the width axis B₁₇. A group I of the inner first channels 22 and inner first webs 24 is highlighted as an example for the right-hand distribution area 20 of FIG. 3A, but is also present in the other distribution areas 20 of FIGS. 3A-B.

Due to the fact that the first channels 22 of the distribution areas 20 have different lengths, inhomogeneous mass flows occur at least after flowing through the distribution areas 20, in FIG. 3B thus at the end 32 of the first webs of the left-hand distribution area 20. These also have an effect on the flow through the second channels 26 of the flow field 17, so that the flow through the flow field 17 can also exhibit corresponding inhomogeneities. It has been shown that this negatively affects the efficiency of the operation of the electrochemical system 1.

In the following FIGS. 4-9, exemplary embodiments are described in views analogous to FIGS. 3A-B in order to limit such efficiency losses. Reference will be made to the explanations in FIGS. 3A-B and FIG. 2 and these apply analogously in the context of FIGS. 4-9, with the exception of the special features described. Variations compared to FIGS. 3A-B and 2 arise in particular with regard to the distribution areas 20, whereas the flow field 17 and the through-openings 11b are designed analogously to FIGS. 3A-B.

FIG. 4 shows a first embodiment in which not all of the first webs 24 of the distribution areas 20 run parallel to one another. Consequently, not all of the first channels 22 formed between and bounded by the first webs 24 are of the same width. In particular, for at least some of the first channels 22, the channel widths increase in the direction of the flow field 17, thus towards the latter. In FIG. 4, this concerns at least the first five lower inner first channels 22 in the left-hand distribution area 20 and along the width axis B₁₇. Optionally, however, constant channel widths or decreasing channel widths can also be provided in the course in the direction of the flow field 17, as shown for some of the upper first channels 22 of the left-hand distribution area 20 in FIG. 4.

As a result, the distances between the first ends 32 of the first webs 24 just as of the inner first webs 24 are inhomogeneous and, in FIG. 4 and with reference to the left-hand distribution area 20, decrease at least on average from vertically below to vertically above. A virtual connecting line V of these first ends 32 is shown as an example. It can be seen in FIG. 4 that in a lower half H2 of the connecting line V there are, at least on average, significantly greater distances between directly adjacent first ends 32 than in the upper half H1. Exemplary distances A1, A2 within the respective halves H1, H2 are shown. In the first half H1, there may be a minimum distance and in the second half H2 a maximum distance. At the same time, the first channels 22, which are delimited by those webs 24 to which the first ends 32 within the lower half H2 belong, are significantly shorter than the first channels 22 associated with the upper half H1.

In FIG. 4, a first outermost first web 24′ and a second outermost first web 24″ are marked. In the view of FIG. 4, the first outermost first web 24′ is positioned in the left-hand distribution area below the second outermost first web 24″. The first end 32 of the first or lower outermost first web 24′ is positioned closer to the through-opening 11b immediately adjacent to the distribution area 20 than the first end 32 of the second or upper outermost first web 24″. The first or lower outermost first web 24′ has a greater and, in particular, a maximum distance to an immediately adjacent inner web 24 than the second or upper outermost first web 24″ has to its immediately adjacent inner web 24. The latter outermost first web 24″ has a minimum distance to its immediately adjacent inner web 24. The minimum and maximum distances refer in each case to the total of the distances A between the adjacent ends 32 of the first webs 24.

The second outermost first web 24″ is the longest first web 24 within a distribution area, while the first outermost web 24′ is the shortest. The same applies to the channels 22 directly adjacent to these webs 24′, 24″.

One result of the described structure of the distribution area 20 is that the inner first channels 22 associated with the lower half H2 are located opposite a larger and, in particular, a maximum number of second channels 26 of the flow field 17, at least on average, than the first channels 22 associated with the upper half H1. This means that the shorter, lower first inner channels 22, through which a higher mass flow results, are directly or predominantly connected to a larger number of second channels 26 of the flow field 17 in a fluid-conducting manner than the comparatively longer first channels 22. This improves the flow behavior of the distribution area 20 and thus increases the efficiency in the operation of an electrochemical system 1 comprising the separator plate 2.

It should be noted that all first webs 24 and first channels 22 are elongate and significantly longer than they are wide. In the example in FIG. 4, they also run in a straight line and without curvature. In addition, they each run at an angle to the longitudinal axis L₁₇, along which a main flow direction also runs through the flow field 17. The first webs 24 are also of similar width and in any case are not significantly wider than the second webs 28, for example not more than three times as wide. Both the first and the second webs 24, 28 have a constant width in the example shown.

Furthermore, the fluid is guided through the first channels 22 and, starting from the through openings 11b, in a substantially identical direction relative to the longitudinal axis L₁₇ or main flow direction to the flow field 17 (or vice versa). In the case of the lower left-hand distribution area 20 in FIG. 4, this relates to a diagonal direction inclined towards the flow field 17. FIG. 4 also shows that the distribution area 20 extends at least almost over the entire width of the flow field 17 and, in particular, the first ends 32 are distributed over almost the entire width.

Finally, FIG. 4 shows that the distances B between neighboring second ends 34 of the first webs 24 are also inhomogeneous in this example shown. Examples of different distances B1, B2 are shown. The second ends 34 are distributed along a virtual connecting line V′. This runs almost along the entire edge section 30 of the through opening 11b, in which the passages 13b are formed.

In FIG. 4, the virtual connecting line V′ runs straight and parallel to the edge section R of the through-opening 11b and parallel to a connecting line, not shown, through the openings 13b′ of the passages 13b and to a macroscopic direction of extension of the sealing element 12b running on this side of the through-opening 11b.

If the ratios of the widths A1, A2 of the first channels 22 adjacent to the first ends 32 of the first webs 24 to the widths B1, B2 of the same first channels 22 adjacent to the second ends 34 of the first webs 24 are considered, A1/B1<A2/B2. Moreover, in the first channel 22 under consideration, A1<B1 while in the second channel 22 under consideration, A2>B2. On the one hand, there are a small number of first channels 22 which become narrower in their course from the edge section 30 to the transition area 36 and a larger number of first channels 22 which become wider over the same distance, whereby most of the increases in width are significantly more pronounced than the decreases.

The longitudinal axis L₁₇ is shown in FIG. 4 in such a way that it separates the separator plate 2 into two halves H1, H2. All second ends 34 of the first webs 24 are arranged in FIG. 4, as in the other embodiments, in the same half of the plate in which the through-opening 11b is also located, with which the first channels 22 communicate directly in a fluidic manner.

FIG. 5 shows a further embodiment, which differs from the example in FIG. 4 primarily in that the first webs 24 each merge into a second web 28 of the flow field 17. However, due to the higher number of channels and webs in the flow field 17 compared to the distribution areas 20, there also remain some webs 28 of the flow field 17 that do not merge into any of the first webs 24. The first webs 24 each extend in a straight line over a large part of their length and are curved near their first ends 32 in the direction of the flow field 17 or of its webs 28. The curvature of all the webs points in the same direction. Their radius points away from the flow field 17 and towards the third side 104.

Once again, the distances A between the first ends 32 of respective adjacent first webs 24 vary analogously to the example in FIG. 4, see the different distances A1, A2. In particular, the first ends 32 can be located where the first webs 24 enter the transition region 36 or also in a center of this transition region 36. Once again, the inhomogeneous distance A is associated with the fact that a different number of second channels 28 of the flow field 17 are located opposite the first channels 22. An inhomogeneity of the distances B between the second ends 34 of the first webs 24, as explained with reference to FIG. 4, is also not shown, but is nevertheless optionally provided.

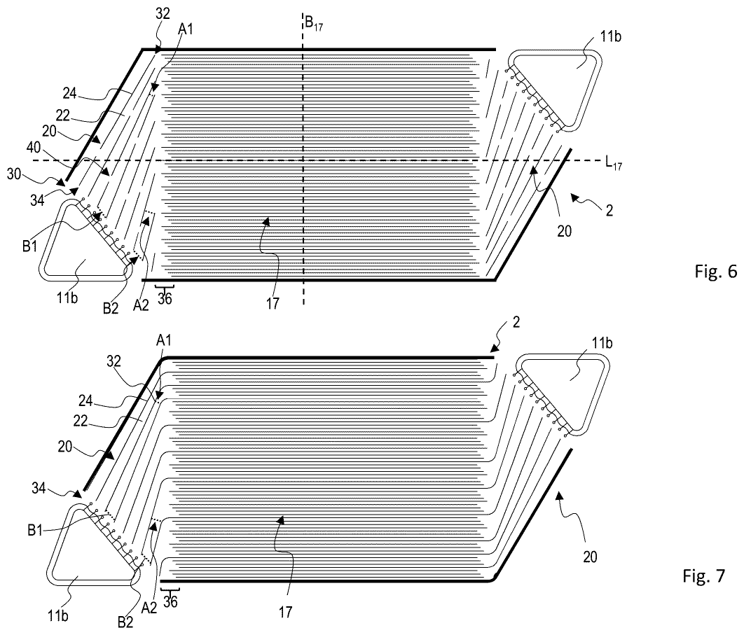

FIG. 6 shows an embodiment comparable to FIG. 4, in which the first webs 24 do not merge directly into the second webs 28 of the flow field 17. Once again, these first webs 24 are straight and run at an angle to the longitudinal axis L₁₇. There are also inhomogeneous distances A1, A2 between the first ends 32 and between the second ends 34 of the first webs 22 (not shown). In contrast to the variant in FIG. 4, however, the webs 24 are locally interrupted, see the depressions 40. Furthermore, in this case the distances between directly adjacent webs 24 and thus the channel widths are reduced when running from one of the through-openings 11b in the direction of the flow field 17. Furthermore, this embodiment differs from that of FIG. 4 in that all channel widths decrease from the edge area 30 to the transition area 36, A<B applies to the ratio A1/B1 as well as to A2/B2.

FIG. 7 shows an embodiment comparable to FIG. 5, in which the first webs 24 each merge into one of the second webs 28 of the flow field 17. Once again, these webs 24 are straight and run at an angle to the longitudinal axis L₁₇. There are also inhomogeneous distances A1, A2 between the first ends 32. The respective distances B1, B2 between the second ends 34 are homogeneous. In the example shown, the distances between at least some neighboring first webs 24 and thus the resulting channel widths decrease starting from the second ends 34 and in the direction of the flow field 17 at least in sections up to the first ends 32. B1>A1 and B2>A2 apply again, at least for the first two channels 22 considered in more detail. Only in the transition area does the width change in the opposite direction, only to increase again in the direction of the flow field 17.

FIGS. 4-7 illustrate—without, however, being conclusive examples—the design scope for achieving the distance inhomogeneity according to the present disclosure.

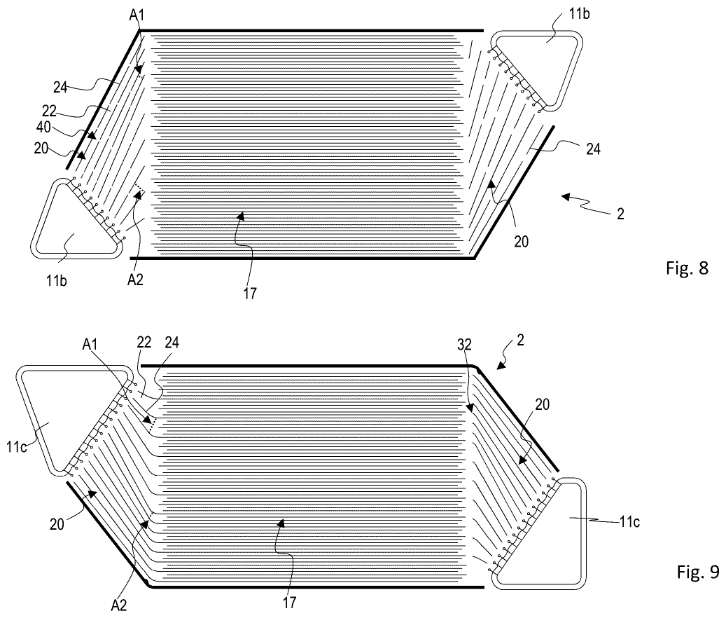

FIG. 8 shows a further embodiment in which the distribution areas 20 are designed differently from one another. The distribution area 20 on the left in FIG. 8 is essentially analogous to the example in FIG. 4, but optionally with local depressions 40 in the first webs 24. The distribution area 20 on the right in FIG. 8, on the other hand, is designed in the same way as the example in FIG. 6. The two distribution areas 20 therefore differ in particular with regard to the number, length and orientation of the first webs 24, the entire length of which extends in the area of the height extension, thus the extension parallel to B₁₇, of the respective adjacent through-opening 11b. One of the distribution areas 20 could also be configured according to an example of the prior art, e.g. both distribution areas 20 do not have to have the distance inhomogeneity according to the present disclosure. However, the latter may increase overall efficiency.

FIG. 9 shows a further embodiment in which the left-hand distribution area 20 is designed in a similar way to the variant in FIG. 5 but has a higher number of webs and channels. The right-hand distribution area 10 has the same number of webs and channels as the left-hand distribution area 20 but differs from it in that none of the webs 24 of the right-hand distribution area 20 merge directly into a web of the flow field 17. Such different designs can be due, for example, to the coolant routing inside the separator plate 2. Furthermore, a fluid-conducting connection to another through-opening 11c is shown in comparison to the preceding FIGS. 3A/B-8. Analogous to the example in FIG. 2, this through-opening 11c can be a through-opening 11c for supplying or discharging fuel, reaction gas and/or discharging the reaction products, whereby the guided media can differ from those of the through-opening 11b. Not only the distribution areas 20 are not point-symmetrical here, but also the through openings 11c, which have different approximate triangular shapes. It should again be pointed out that not all of the through-openings 11a-c of the separator plates 2 are shown in the schematic partial views of FIGS. 3A/B-9 but may be present there analogous to the example in FIG. 2.

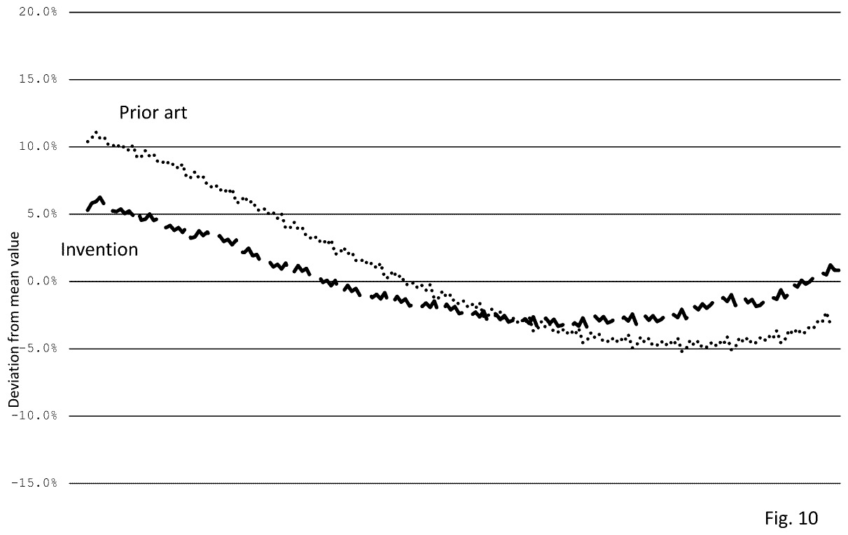

FIG. 10 shows a diagram illustrating an improved homogeneity of the mass flow at half the length of the flow field 17 when flowing through a surface of a separator plate according to any of the embodiments of the present disclosure disclosed herein. Deviations from an average mass flow are plotted along the vertical axis of the diagram. The curves shown are presented only as smoothed curves. The channels of the flow field 17 of a point-symmetrical separator plate 2 are shown from left to right, e.g. the horizontal direction corresponds, for example, to a view along the width axis B₁₇ in FIG. 4 and positions in the horizontal direction correspond to positions of these channels along the width axis B₁₇.

The dashed line indicates values achieved with an embodiment according to the present disclosure. The dotted line indicates values achieved with a prior art separator plate. It can be seen that the embodiment according to the present disclosure reduces the fluctuations in the mass flow compared to the prior art. For example, the dashed line runs at a shorter distance from the horizontal diagram axis 0.0% than the dotted line over long stretches. As mentioned, the improved homogeneity of the mass flow according to the present disclosure is accompanied by an overall improved and therefore efficiency-enhancing flow behavior of the distribution areas 20 and also of the flow field 17.

1. A separator plate for an electrochemical system, having:
at least one through-opening for passing a fluid through the separator plate,
at least one distribution area having a plurality of first channels and first webs formed between each two first channels, and
at least one flow field, which is in fluid communication with the through-opening via the distribution area and which has a plurality of second channels and second webs formed between each two second channels,
wherein first ends of the first webs face ends of the second webs and/or merge into the ends of at least selected ones of the second webs, and
wherein first distances between the respective first ends of mutually adjacent first webs are inhomogeneous.

2. The separator plate according to claim 1,
wherein the first ends of the first webs are distributed along a width axis of the separator plate and the distribution area has a first outermost first web and a second outermost first web as viewed along the width axis,
wherein inner first webs are arranged between these two outermost first webs, and
wherein, for the inner first webs, the first distances between the respective first ends of mutually adjacent first webs are inhomogeneous.

3. The separator plate according to claim 1,
further comprising a transition region in which the first ends of the first webs face the ends of the second webs and/or in which the first ends of the first webs merge into the ends of the at least selected ones of the second webs,
wherein the transition region is lowered, with respect to a height axis extending perpendicular to a flat surface plane of the separator plate, relative to the flow field and/or to the distribution area.

4. The separator plate according to claim 1, wherein the fluid in the flow field flows along a main flow direction and:
the first webs and/or first channels each extend at an angle to this main flow direction, and/or
a virtual connecting line of the first ends of the first channels is substantially orthogonal to the main flow direction and/or
the distribution area extends along an entire width of the flow field, the width being measured orthogonally to the main flow direction, and/or
the first distances are measured orthogonally to the main flow direction.

5. The separator plate according to claim 1,
wherein distances between the respective ends of mutually adjacent second channels are homogeneous or less inhomogeneous than the first distances; and/or
wherein a number of first channels is less than a number of second channels, wherein the number of first channels is not more than half as large as the number of second channels.

6. The separator plate according to claim 1,
wherein the first ends of the first webs are distributed along a width axis of the separator plate and the distribution area, when viewed along the width axis has a first outermost first web and a second outermost first web,
wherein the first end of the first outermost first web is positioned closer to the through-opening than the first end of the second outermost first web, and
wherein:
along the width axis and viewed from the first outermost first web in a direction of the second outermost first web, the first distances decrease at least in sections and/or
along the width axis and viewed from the first outermost first web in the direction of the second outermost first web, the first distances, at least in sections, do not increase and/or
along the width axis and viewed from the second outermost first web in the direction of the first outermost first web, the first distances increase at least in sections.

7. The separator plate according to claim 6,
wherein a maximum first distance is present at least between the first outermost first web and a further first web directly adjacent thereto, and/or
wherein a minimum first distance is present at least between the second outermost first web and the further first web directly adjacent thereto.

8. The separator plate according to claim 1, wherein each first channel is arranged to supply fluid to or receive fluid from at least one associated second channel, wherein a number of second channels associated with a respective first channel is inhomogeneous.

9. The separator plate according to claim 8, wherein the number of second channels associated with a respective first inner channel arranged between inner first webs is inhomogeneous, wherein the inner first webs are arranged between two outermost first webs.

10. The separator plate according to claim 1,
wherein a respective width of a web of the first webs is constant or varies by no more than 20% along a respective length of a first web; and/or
wherein the respective widths of the first webs are identical and/or do not deviate from one another by more than 20%.

11. The separator plate according to claim 1, wherein the first webs are substantially kink-free and/or substantially curvature-free over at least two thirds of their length.

12. The separator plate according to claim 1, wherein the first webs extend non-parallel to one another along at least half of their length.

13. The separator plate according to claim 1, wherein the first webs are not more than five times as wide as the second webs.

14. The separator plate according to claim 1, wherein second ends of the first webs face the through-opening and are connected to one another by a virtual connecting line, wherein the through-opening is arranged along a first edge section for a fluid-conducting connection with the distribution area, and wherein the first edge section extends along at least one third of the virtual connecting line.

15. The separator plate according to claim 1, wherein second ends of the first webs face the through-opening and are connected to one another by a virtual connecting line, wherein the virtual connecting line and an edge section of the through-opening extend at a constant distance from one another over at least half of their course.

16. The separator plate according to claim 1,
wherein second ends of the first webs face the through-opening, and
wherein at least some distances between the respective second ends of mutually adjacent first webs are homogeneous.

17. The separator plate according to claim 1,
wherein second ends of the first webs are distributed along a width axis of the separator plate and the distribution area has a first outermost first web and a second outermost first web as viewed along the width axis,
wherein inner first webs are arranged between these two outermost first webs, and
wherein first distances between the respective second ends of mutually adjacent first webs are homogeneous for the inner first webs.

18. The separator plate according to claim 1, wherein for at least 80% of the first channels and/or the first webs, the first channels and/or the first webs are at least five times as long as they are wide.

19. A separator plate for an electrochemical system, having:
at least one through-opening for passing a fluid through the separator plate,
at least one distribution area having a plurality of first channels and first webs formed between each two first channels, and
at least one flow field which is in fluid connection with the through-opening via the distribution area,
wherein second ends of the first webs face the through-opening, and
wherein at least some distances between the respective second ends of mutually adjacent first webs are inhomogeneous.

20. The separator plate according to claim 19,
wherein the second ends of the first webs are distributed along a width axis of the separator plate and the distribution area, when viewed along the width axis has a first outermost first web and a second outermost first web,
wherein first inner webs are arranged between the first outermost first web and the second outermost first web, and
wherein for the first inner webs, distances between the respective second ends of mutually adjacent first webs are inhomogeneous.
